(19) United States
(12) Patent Application Publication
(10) Pub. No.: US 2023/0169414 A1
(43) Pub. Date: Jun. 1, 2023

(54) POPULATION EXTRACTION DEVICE

(71) Applicant: NTT DOCOMO, INC., Chiyoda-ku (JP)

(72) Inventors: Shu ISHIKAWA, Chiyoda-ku (JP); Yusuke FUKAZAWA, Chiyoda-ku (JP); Satoshi KAWASAKI, Chiyoda-ku (JP); Shin ISHIGURO, Chiyoda-ku (JP); Tomohiro MIMURA, Chiyoda-ku (JP)

(73) Assignee: NTT DOCOMO, INC., Chiyoda-ku (JP)

(21) Appl. No.: 17/995,475

(22) PCT Filed: Feb. 17, 2021
(86) PCT No.: PCT/JP2021/005959

§ 371 Date: Oct. 4, 2022

(30) Foreign Application Priority Data
Apr. 23, 2020 (JP) 2020-076811

(51) Int. Cl. G06Q 10/04; G06F 16/906

(52) U.S. Cl. CPC G06Q 10/04; G06F 16/906

(57) ABSTRACT

A population extraction device includes: a time-series population acquisition unit acquiring demographic data in daily time slots over a time period in a target area and acquiring a time-series population in a time slot each day by extracting a population at the same time slots from the demographic data in daily time slots; a clustering unit clustering the time-series population in a time slot each day into a plurality of classes based on fluctuation-similarity; a determination unit determining a class on a no-event day based on fluctuation in each class; a stationary population derivation unit deriving a time-series average population of the class on a no-event day as a time-series stationary population of a target area; and a population extraction unit extracting a difference between the time-series population on a target day in a target area and the time-series stationary population as an event-related population of the target area.

### TECHNICAL FIELD

The present disclosure relates to a population extraction device that extracts a population related to an event (hereinafter referred to as an “event-related population”).

### BACKGROUND ART

When a certain event is held, there is a need to extract the number of people related to the event (event-related population). On the other hand, a technique related to demographic statistics for estimating the number of people residing (resident population) in a certain area in a certain time slot on the basis of information on the position of mobile terminals or the like has been proposed. For example, regarding an event, the following Patent Literature 1 proposes a technique of determining the presence or absence of an event in a certain area in a certain time slot from the estimated value of the resident population in the area in the time slot.

### CITATION LIST

### Patent Literature

[Patent Literature 1] Japanese Unexamined Patent Publication No. 2011-108193

### SUMMARY OF INVENTION

### Technical Problem

However, Patent Literature 1 does not propose the extraction of an event-related population, and thus there is a long-awaited technique of extracting an event-related population with a good degree of accuracy.

In order to solve the above problem, an object of the present disclosure is to extract an event-related population with a good degree of accuracy.

### Solution to Problem

According to the present disclosure, there is provided a population extraction device including: a time-series population acquisition unit configured to acquire demographic data in different daily time slots over a certain period of time in a target area and acquire a time-series population in a predetermined time slot on each day by extracting a population at each of the same time slots determined from the acquired demographic data in different daily time slots; a clustering unit configured to cluster the time-series population in a predetermined time slot on each day acquired by the time-series population acquisition unit into a plurality of classes on the basis of a similarity of fluctuations; a determination unit configured to determine a class on a day when there is no event on the basis of a degree of fluctuation in each class among a plurality of classes obtained by clustering performed by the clustering unit; a stationary population derivation unit configured to derive a time-series average population of the class on a day when there is no event determined by the determination unit as a time-series stationary population of a target area; and a population extraction unit configured to extract a difference between the time-series population on a target day in a target area acquired by the time-series population acquisition unit and the time-series stationary population of a target area derived by the stationary population derivation unit as an event-related population of the target area.

In the above population extraction device, the time-series population acquisition unit acquires demographic data in different daily time slots over a certain period of time in a target area and acquires a time-series population in a predetermined time slot on each day by extracting a population at each of the same time slots determined from the acquired demographic data in different daily time slots, the clustering unit clusters the time-series population in a predetermined time slot on each day acquired by the time-series population acquisition unit into a plurality of classes on the basis of a similarity of fluctuations, and the determination determines a class on a day when there is no event on the basis of a degree of fluctuation in each class among a plurality of classes obtained by the clustering. Further, the stationary population derivation unit derives a time-series average population of the class on a day when there is no event as a time-series stationary population of a target area, and the population extraction unit extracts a difference between the time-series population on a target day in a target area acquired by the time-series population acquisition unit and the time-series stationary population of a target area derived by the stationary population derivation unit as an event-related population of the target area.

In this way, the population extraction device clusters the time-series population in a predetermined time slot on each day into a plurality of classes on the basis of the similarity of fluctuations, then automatically and appropriately determines a class on a day when there is no event on the basis of the degree of fluctuation in each class, further derives the time-series average population of the class on a day when there is no event as a time-series stationary population of a target area, and extracts a difference between the time-series population and the time-series stationary population on a target day in a target area as an event-related population of the target area. Thereby, after removing a population which is not related to an event, for example, a population of people who happened to stay near the event venue, it is possible to extract an event-related population with a good degree of accuracy. In addition, since a day when there is no event can be automatically determined, it is possible to save the time and effort of acquiring information on a day in advance when there is an event or a day when there is no event.

### Advantageous Effects of Invention

According to the present disclosure, it is possible to extract an event-related population with a good degree of accuracy. In addition, since a day when there is no event can be automatically determined, it is possible to save the time and effort of acquiring information on a day in advance when there is an event or a day when there is no event.

### BRIEF DESCRIPTION OF DRAWINGS

FIG. 1 is a functional block diagram illustrating a configuration of a population extraction device.

FIG. 2 is a table illustrating an example of acquired demographic information.

FIG. 3 is a diagram illustrating a process of obtaining a time-series stationary population.

FIG. 4 is a diagram illustrating a principle of extraction of an event-related population.

FIG. 5 is a table illustrating an output example of the event-related population.

FIG. 6 is a flow diagram illustrating a process which is executed in a population extraction device.

FIG. 7 is a flow diagram illustrating a process of determining a class on a day when there is no event.

FIG. 8 is a diagram illustrating a hardware configuration example of the population extraction device.

### DESCRIPTION OF EMBODIMENTS

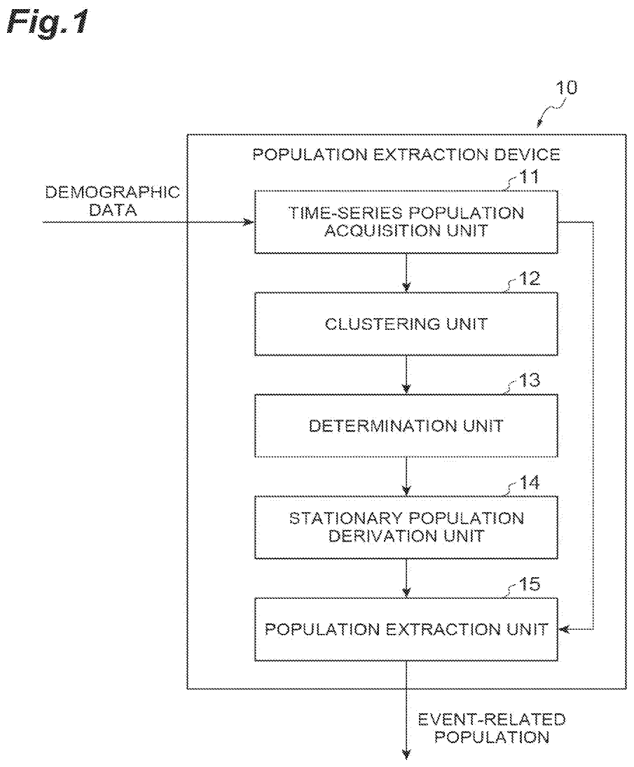

Hereinafter, an embodiment of a population extraction device will be described. As shown in FIG. 1, a population extraction device 10 according to the present embodiment includes a time-series population acquisition unit 11, a clustering unit 12, a determination unit 13, a stationary population derivation unit 14, and a population extraction unit 15. Hereinafter, the function, operation, and the like of each unit will be described.

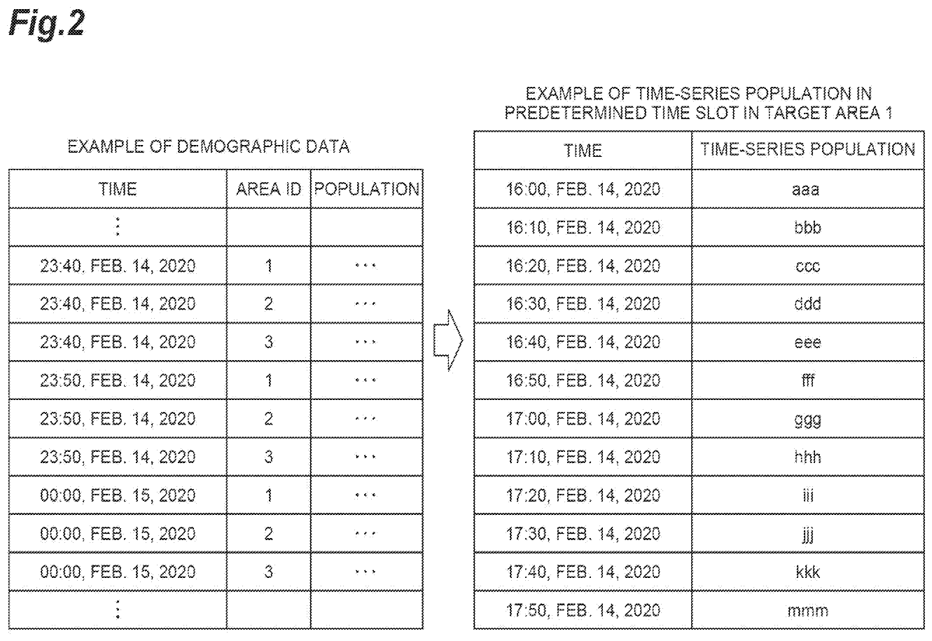

The time-series population acquisition unit 11 is a functional unit that acquires demographic data in different daily time slots over a certain period of time in a target area from an external server (not shown) and acquires a time-series population in a predetermined time slot on each day by extracting a population at each of the same time slots determined from the acquired demographic data in different daily time slots. As the above demographic data, for example, demographic data obtained using a population calculation method based on information or the like on the position of a user terminal disclosed in International Patent Publication WO 2012/056900 can be adopted. For example, demographic data in different daily time slots over a certain period of time in a target area 1 (area with area ID=1) is acquired from demographic data every ten minutes in a plurality of areas such as the left side of FIG. 2, and a time-series population in a predetermined time slot on each day is acquired by extracting a population at each of the same time slots determined from the acquired demographic data in different daily time slots. For example, a time-series population in a predetermined time slot (16:00 to 17:50) is acquired as shown on the right side of FIG. 2 from demographic data in different time slots on Feb. 14, 2020. The acquisition such a time-series population is executed on each day.

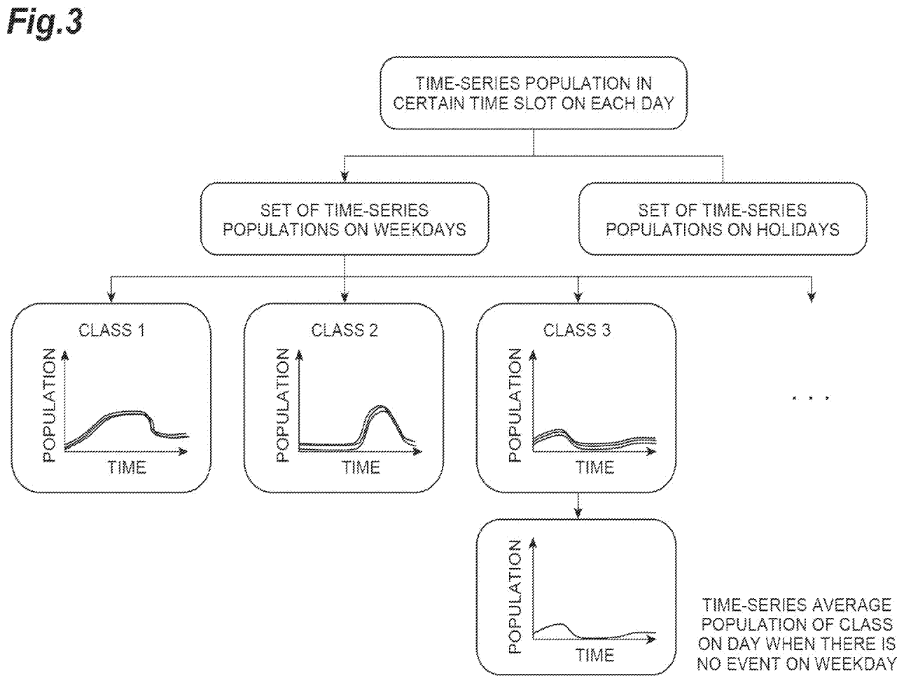

The clustering unit 12 is a functional unit that clusters the time-series population in a predetermined time slot on each day acquired by the time-series population acquisition unit 11 into a plurality of classes on the basis of the similarity of fluctuations. In order to perform classification with a better degree of accuracy, the clustering unit 12 in the present embodiment divides the time-series population in a predetermined time slot on each day by weekday/holiday or by day of the week into a plurality of sets, and clusters each of the plurality of sets into a plurality of classes on the basis of the similarity of fluctuations. FIG. 3 shows an example of division by weekday/holiday, and the clustering unit 12 divides the time-series population in a predetermined time slot on each day into a set of time-series populations on weekdays and a set of time-series populations on holidays, and then clusters each of the plurality of sets into a plurality of classes on the basis of the similarity of fluctuations. FIG. 3 shows an example in which a set of time-series populations on weekdays is clustered into a plurality of classes such as classes 1, 2, 3, . . . consisting of those having similar fluctuations.

The determination unit 13 is a functional unit that determines a class on a day when there is no event on the basis of the degree of fluctuation in each class among a plurality of classes obtained by clustering performed by the clustering unit 12. Although the details will be described later, the determination unit 13 determines a class having the smallest degree of fluctuation in each class among the plurality of classes as a class on a day when there is no event.

The stationary population derivation unit 14 is a functional unit that derives a time-series average population of the class on a day when there is no event determined by the determination unit 13 as a time-series stationary population of a target area.

The population extraction unit 15 is a functional unit that extracts a difference between the time-series population on a target day in a target area acquired by the time-series population acquisition unit 11 and the time-series stationary population of a target area derived by the stationary population derivation unit 14 as an event-related population of the target area.

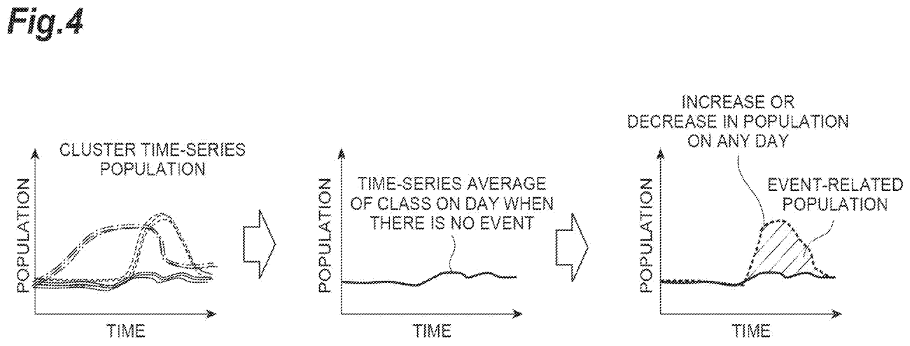

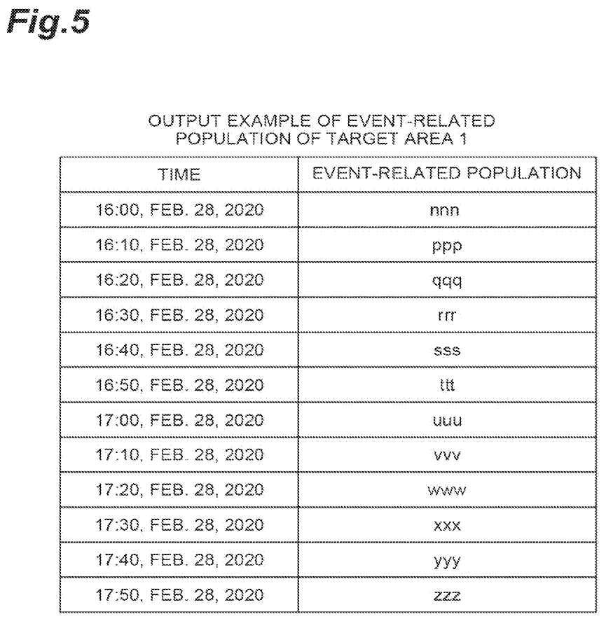

As shown in FIG. 4, the clustering unit 12 clusters the time-series population in a predetermined time slot on each day into a plurality of classes consisting of those having similar fluctuations, the determination unit 13 determines a class having the smallest degree of fluctuation in each class as a class on a day when there is no event, the stationary population derivation unit 14 derives a time-series average population of the class on a day when there is no event as a time-series stationary population of a target area, and the population extraction unit 15 further extracts a difference between the time-series population and the time-series stationary population on a target day in a target area (a hatched portion in the graph at the right end of FIG. 4) as an event-related population of the target area. As shown in FIG. 5, the population extraction unit 15 outputs an event-related population in a predetermined time slot (for example, 16:00 to 17:50) on a target day (for example, Feb. 28, 2020) in a target area.

(Processing Executed in Population Extraction Device)

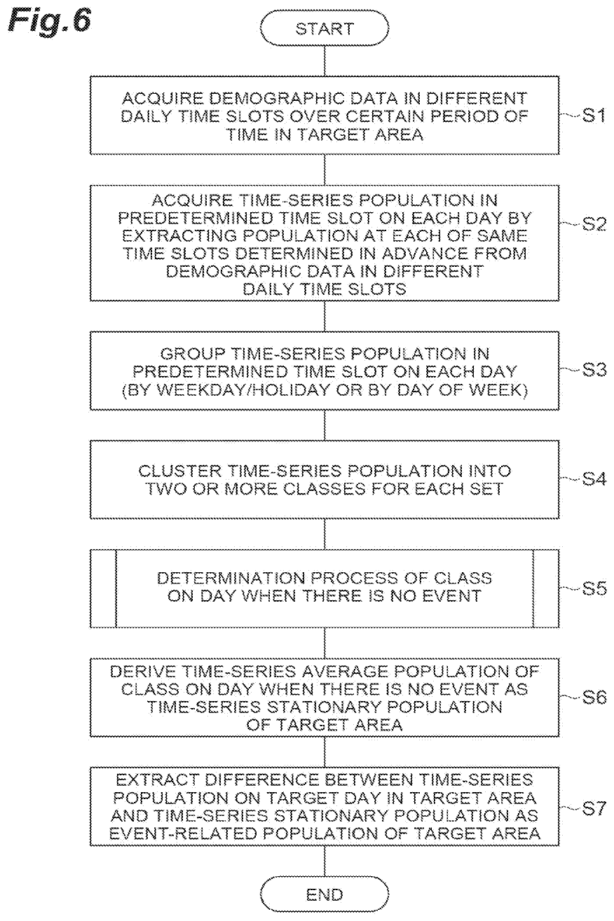

Hereinafter, an example of processing executed in the population extraction device 10 will be described. FIG. 6 shows the entire processing. Meanwhile, the processing of FIG. 6 may be executed at a predetermined time interval, or may be executed at any timing (such as, for example, a timing at which a user instructs the start of execution or a timing designated in advance by the user). Hereinafter, each process will be described.

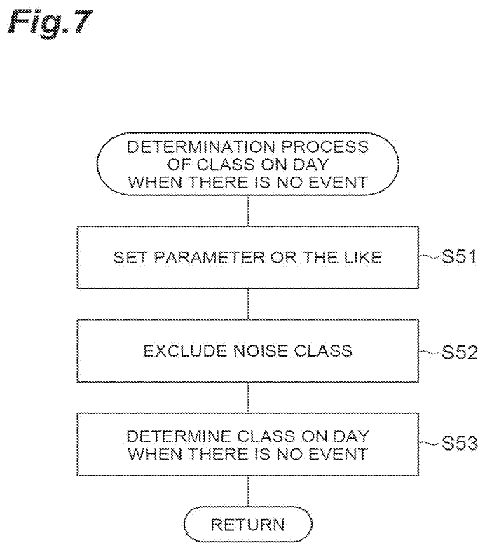

First, the time-series population acquisition unit 11 acquires demographic data in different daily time slots over a certain period of time in a target area (step S1 in FIG. 6), and acquires a time-series population in a predetermined time slot on each day by extracting a population at each of the same time slots determined from the demographic data in different daily time slots (step S2). Next, the clustering unit 12 groups the time-series population in a predetermined time slot on each day by weekday/holiday or by day of the week (step S3), and clusters the time-series population into two or more classes for each set (step S4). Next, the determination unit 13 executes a process of determining a class on a day when there is no event (FIG. 7) (step S5). In step S5, as parameter settings, the determination unit 13 sets each of the plurality of classes to be determined as Cₙ(n∈{1, 2, . . . , N}), sets the time-series population included in each class as the following Expression 1,

x_{n,i}∈Cₙ(i∈{1,2, . . . ,|Cₙ|}) [Expression 1]

sets a time width extracted from the time-series population on each day as T (T is a positive integer), and sets a threshold of the size of a noise class due to the influence of a disaster or the like as σ (step S51 in FIG. 7). Next, the determination unit 13 determines the class Cₙ having a relation of |Cₙ|<σ as a noise class, and excludes the noise class from a plurality of classes which are targets for the determination process (step S52). The determination unit 13 then determines a class Cₙ such as the following Expression 2 as a class on a day when there is no event (step S53).

$${argmin}_{{C}_{n}} \frac{1}{\vert {C}_{n} \vert T} {\sum }_{i = 1}^{\vert {C}_{n} \vert} {\sum }_{t = 1}^{T} {x}_{n , i}^{t} \qquad [ Expression 2 ]$$

In this case, when the time-series average population in the class G is expressed as

x̅ₙ̅,

the time-series average population at each time t expressed as

x̅ₙ̅^̅{̅t̅}̅

is obtained by the following expression.

$$\overline{{x}_{n}^{t}} = \frac{1}{\vert {C}_{n} \vert} {\sum }_{i = 1}^{\vert {C}_{n} \vert} {x}_{n , i}^{t}$$

Therefore, since the class Cₙ for which the average value of the above time-series average population over the entire time width is minimized can be determined as a class for which the fluctuation of the time-series population in the above time width is smallest, such a class Cₙ can be determined as a class on a day when there is no event.

Referring back to FIG. 6, in next step S6, the stationary population derivation unit 14 derives the time-series average population of the class on a day when there is no event obtained in the determination result as a time-series stationary population of a target area (step S6), and the population extraction unit 15 further extracts a difference between the time-series population on a target day in a target area acquired by the time-series population acquisition unit 11 and the derived time-series stationary population of a target area as an event-related population of the target area (step S7). Thereafter, for example, the event-related population in a predetermined time slot (for example, 16:00 to 17:50) on a target day (for example, Feb. 28, 2020) in a target area as shown in FIG. 5 is output from the population extraction unit 15 to the outside (for example, a user).

As described above, the population extraction device 10 clusters the time-series population in a predetermined time slot on each day into a plurality of classes on the basis of the similarity of fluctuations, then automatically and appropriately determines a class on a day when there is no event on the basis of the degree of fluctuation in each class, further derives the time-series average population of the class on a day when there is no event as a time-series stationary population of a target area, and extracts a difference between the time-series population and the time-series stationary population on a target day in a target area as an event-related population of the target area. Thereby, after removing a population which is not related to an event, for example, a population of people who happened to stay near the event venue, it is possible to extract an event-related population with a good degree of accuracy. In addition, since a day when there is no event can be automatically determined, it is possible to save the time and effort of acquiring information on a day in advance when there is an event or a day when there is no event.

Meanwhile, FIG. 3 shows an example in which the clustering unit 12 groups a time-series population in a predetermined time slot on each day by weekday/holiday, but the clustering unit may group the time-series population by day of the week. It is not an essential requirement to group the time-series population in a predetermined time slot on each day by weekday/holiday or by day of the week. However, more accurate clustering can be performed by grouping by weekday/holiday or by day of the week.

[Terms, Variants, and the Like]

Meanwhile, the block diagram used in the description of the above embodiment represents blocks in units of functions. These functional blocks (constituent elements) are realized by any combination of at least one of hardware and software. In addition, a method of realizing each functional block is not particularly limited. That is, each functional block may be realized using one device which is physically or logically coupled, or may be realized using two or more devices which are physically or logically separated from each other by connecting the plurality of devices directly or indirectly (for example, using a wired or wireless manner or the like). The functional block may be realized by combining software with the one device or the plurality of devices.

Examples of the functions include determining, deciding, judging, calculating, computing, processing, deriving, investigating, searching, ascertaining, receiving, transmitting, outputting, accessing, resolving, selecting, choosing, establishing, comparing, assuming, expecting, considering, broadcasting, notifying, communicating, forwarding, configuring, reconfiguring, allocating (or mapping), assigning, and the like, but there is no limitation thereto. For example, a functional block (constituent element) for allowing a transmitting function is referred to as a transmitting unit or a transmitter. As described above, realization methods are not particularly limited.

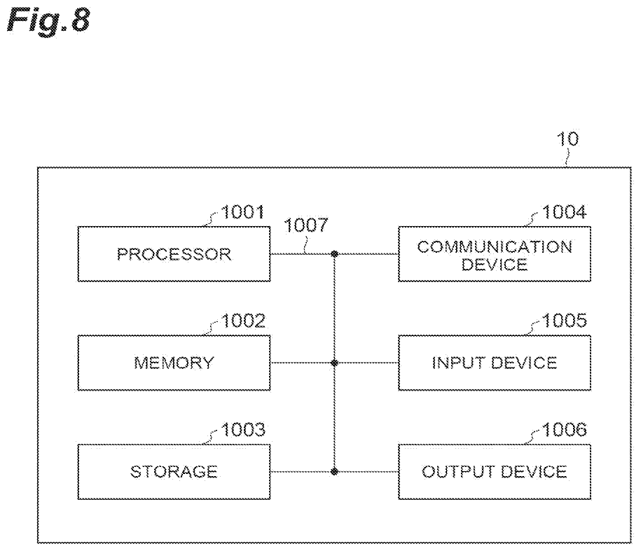

For example, the population extraction device in an embodiment may function as a computer that performs processing in the present embodiment. FIG. 8 is a diagram illustrating a hardware configuration example of the population extraction device 10. The above-described the population extraction device 10 may be physically configured as a computer device including a processor 1001, a memory 1002, a storage 1003, a communication device 1004, an input device 1005, an output device 1006, a bus 1007, and the like.

Meanwhile, in the following description, the word “device” may be replaced with “circuit,” “unit,” or the like. The hardware configuration of the population extraction device 10 may be configured to include one or a plurality of devices shown in the drawings, or may be configured without including some of the devices.

The processor 1001 performs an arithmetic operation by reading predetermined software (a program) onto hardware such as the processor 1001 or the memory 1002, and thus each function of the population extraction device 10 is realized by controlling communication in the communication device 1004 or controlling at least one of reading-out and writing of data in the memory 1002 and the storage 1003.

The processor 1001 controls the whole computer, for example, by operating an operating system. The processor 1001 may be constituted by a central processing unit (CPU) including an interface with a peripheral device, a control device, an arithmetic operation device, a register, and the like.

In addition, the processor 1001 reads out a program (a program code), a software module, data, or the like from at least one of the storage 1003 and the communication device 1004 into the memory 1002, and executes various types of processes in accordance therewith. An example of the program which is used includes a program causing a computer to execute at least some of the operations described in the foregoing embodiment. Although the execution of various types of processes by one processor 1001 has been described above, these processes may be simultaneously or sequentially executed by two or more processors 1001. One or more chips may be mounted in the processor 1001. Meanwhile, the program may be transmitted from a network through an electrical communication line.

The memory 1002 is a computer readable recording medium, and may be constituted by at least one of, for example, a read only memory (ROM), an erasable programmable ROM (EPROM), an electrically erasable programmable ROM (EEPROM), a random access memory (RAM), and the like. The memory 1002 may be referred to as a register, a cache, a main memory (main storage device), or the like. The memory 1002 can store a program (a program code), a software module, or the like that can be executed in order to carry out a wireless communication method according to an embodiment of the present disclosure.

The storage 1003 is a computer readable recording medium, and may be constituted by at least one of, for example, an optical disc such as a compact disc ROM (CD-ROM), a hard disk drive, a flexible disk, a magneto-optic disc (for example, a compact disc, a digital versatile disc, or a Blu-ray (registered trademark) disc), a smart card, a flash memory (for example, a card, a stick, or a key drive), a floppy (registered trademark) disk, a magnetic strip, and the like. The storage 1003 may be referred to as an auxiliary storage device. The foregoing storage medium may be, for example, a database including at least one of the memory 1002 and the storage 1003, a server, or another suitable medium.

The communication device 1004 is hardware (a transmitting and receiving device) for performing communication between computers through at least one of a wired network and a wireless network, and is also referred to as, for example, a network device, a network controller, a network card, a communication module, or the like.

The input device 1005 is an input device (such as, for example, a keyboard, a mouse, a microphone, a switch, a button, or a sensor) that receives an input from the outside. The output device 1006 is an output device (such as, for example, a display, a speaker, or an LED lamp) that executes an output to the outside. Meanwhile, the input device 1005 and the output device 1006 may be an integrated component (for example, a touch panel). In addition, respective devices such as the processor 1001 and the memory 1002 are connected to each other through the bus 1007 for communicating information. The bus 1007 may be configured using a single bus, or may be configured using a different bus between devices.

The aspects/embodiments described in the present disclosure may be used alone, may be used in combination, or may be switched during implementation thereof. In addition, notification of predetermined information (for example, notification of “X”) is not limited to explicit transmission, and may be performed by implicit transmission (for example, the notification of the predetermined information is not performed).

Hereinbefore, the present disclosure has been described in detail, but it is apparent to those skilled in the art that the present disclosure should not be limited to the embodiments described in the present disclosure. The present disclosure can be implemented as modified and changed aspects without departing from the spirit and scope of the present disclosure, which are determined by the description of the scope of claims.

Therefore, the description of the present disclosure is intended for illustrative explanation only, and does not impose any limited interpretation on the present disclosure.

The order of the processing sequences, the sequences, the flowcharts, and the like of the aspects/embodiments described above in the present disclosure may be changed as long as they are compatible with each other. For example, in the methods described in the present disclosure, various steps as elements are presented using an exemplary order but the methods are not limited to the presented specific order.

The input or output information or the like may be stored in a specific place (for example, a memory) or may be managed using a management table. The input or output information or the like may be overwritten, updated, or added. The output information or the like may be deleted. The input information or the like may be transmitted to another device.

An expression “on the basis of” which is used in the present disclosure does not refer to only “on the basis of only,” unless otherwise described. In other words, the expression “on the basis of” refers to both “on the basis of only” and “on the basis of at least.”

In the present disclosure, when the terms “include,” “including,” and modifications thereof are used, these terms are intended to have a comprehensive meaning similarly to the term “comprising.” Further, the term “or” which is used in the present disclosure is intended not to mean an exclusive logical sum.

In the present disclosure, when articles are added by translation like, for example, “a,” “an” and “the” in English, the present disclosure may include that nouns that follow these articles are plural forms.

In the present disclosure, an expression “A and B are different” may mean that “A and B are different from each other.” Meanwhile, the expression may mean that “A and B are different from C.” The terms “separated,” “coupled,” and the like may also be construed similarly to “different.”

### REFERENCE SIGNS LIST

10: Population extraction device; 11: Time-series population acquisition unit; 12: Clustering unit; 13: Determination unit; 14: Stationary population derivation unit; 15: Population extraction unit; 1001: Processor; 1002: Memory; 1003: Storage; 1004: Communication device; 1005: Input device; 1006: Output device; 1007: Bus.

1. A population extraction device comprising circuitry configured to:
acquire demographic data in different daily time slots over a certain period of time in a target area and acquire a time-series population in a predetermined time slot on each day by extracting a population at each of the same time slots determined from the acquired demographic data in different daily time slots;
cluster the time-series population in a predetermined time slot on each day acquired by the time-series population acquisition unit into a plurality of classes on the basis of a similarity of fluctuations;
determine a class on a day when there is no event on the basis of a degree of fluctuation in each class among a plurality of classes obtained by clustering performed by the circuitry;
derive a time-series average population of the class on a day when there is no event determined by the circuitry as a time-series stationary population of a target area; and
extract a difference between the time-series population on a target day in a target area acquired by the circuitry and the time-series stationary population of a target area derived by the circuitry as an event-related population of the target area.

2. The population extraction device according to claim 1,
wherein the circuitry is configured to divide the time-series population in a predetermined time slot on each day acquired by the circuitry by weekday/holiday or by day of the week into a plurality of sets, and clusters each of the plurality of sets into a plurality of classes on the basis of the similarity of fluctuations.

3. The population extraction device according to claim 1, wherein the circuitry is configured to exclude classes for which the number of time-series populations included in the class is less than a threshold determined from the plurality of classes and determine a class on a day when there is no event from a plurality of classes excluded.

4. The population extraction device according to claim 1,
wherein, in a case where each of the plurality of classes to be determined is set as Cₙ (n∈{1, 2, . . . , N}), the time-series population included in each class is set as Expression 1 as follows, and
x_{n,i}∈Cₙ(i∈{1,2, . . . ,|Cₙ|}) [Expression 1], and
a time width extracted from the time-series population on each day is set as T (T is a positive integer) the circuitry is configured to determine a class Cₙ such as Expression 2 as a class on a day when there is no event wherein Expression 2 is as follows
$${argmin}_{{C}_{n}} \frac{1}{\vert {C}_{n} \vert T} {\sum }_{i = 1}^{\vert {C}_{n} \vert} {\sum }_{t = 1}^{T} {x}_{n , i}^{t} . \qquad [ Expression 2 ]$$

5. The population extraction device according to claim 2,
wherein the circuitry is configured to exclude classes for which the number of time-series populations included in the class is less than a threshold determined from the plurality of classes and determine a class on a day when there is no event from a plurality of classes excluded.
